(19) United States
(12) Patent Application Publication
(10) Pub. No.: US 2002/0026323 A1
(43) Pub. Date: Feb. 28, 2002

(54) Method and system for annotating a window shared by remote hosts

(75) Inventors: Akira Sakaguchi, Tokyo-to (JP); Masato Yokote, Kawasaki-shi (JP)

Correspondence Address: A. Bruce Clay, IBM Corporation, T81/503, PO Box 12195, Research Triangle Park, NC, 27709, US

(73) Assignee: International Business Machines Corporation, Armonk, NY (US)

(21) Appl. No.: 09/927,155

(22) Filed: Aug. 10, 2001

(30) Foreign Application Priority Data
Aug. 31, 2000 (JP) 2000-262297

(51) Int. Cl. G06F 17/60

(52) U.S. Cl. 705/1

(57) ABSTRACT

An annotation object is formed and stored independently of an application that constructed an application window. A window is shaped to display the stored annotation object. The annotation object is selected and displayed in the application window. An annotation object window is shaped by a window shaping unit at the location designated in the application window.

### FIELD OF THE INVENTION

The present invention relates to a method for annotating an arbitrary window, for example, one that is shared by remote hosts.

### BACKGROUND OF THE INVENTION

A computer system, for supporting the collaboration of multiple users allows the transmission or sharing of qualitative knowledge and information that could not be handled by previously available systems. This system can, for example, add images or graphs to basic data (product data, customer data and sales records), conventionally accumulated in text, so as to share data and thus render it more useful. Further, the system allows joint development of products, or joint studies, with associated companies, and for the joint management of projects. In addition, the system can rationalize the process through the sharing of information with vendors and/or suppliers. Furthermore, when the range for the exchange of information is expanded to include the Internet, upon the receipt of an inquiry from a remote customer, for example, a salesperson can output the requested product information to the browser of the customer and provide a supplemental explanation, or can, when appropriate, take an order. All things being equal, it is therefore anticipated that this system will contribute to an increase in mobile offices and in stay-at-home working.

One application for promoting collaboration is the product Web Collaboration, by the present applicant (IBM Corp.), that has as its primary purpose the sharing of HTML documents for web servers. Additional, similar products are NetMeeting, by Microsoft, for the primary purpose of sharing applications running on a variety of PCs, and Freelance Team Screen Show, by Lotus, which has as its main purpose the synchronous browsing of a screen show by multiple PCs. Web Collaboration, for example, uses JavaScript to write a process for a predetermined event by taking the form of an input screen prepared using HTML, and performs upon the occurrence of an event during an input operation. When this application is used for an automatic contract machine installed in a bank, the contents of the input screen related to bank procedures and to the state of an operation by a customer can be shared by remote hosts. Therefore, the degree of understanding established between the customer and the bank can be increased, and the smooth communication of data can be expected.

While Web Collaboration uses an annotation function as a tool for collaboration between remote hosts, the annotation function can also be used to write additional data at a specific location on a screen to draw the attention of another person, and to provide a supplementary explanation. According to this annotation function, when remote hosts collaborate, with a screen and an application being shared, the hosts can converse with each other while highlighting specific points on the screen. With Web Collaboration, an annotation is effected using a method that provides for the writing of data in the plug-in window of a web browser. When the object of an annotation is expanded to take in more than the web browser, and the annotation is employed for content (Shockwave or an Applet) using a plug-in window, the object to be annotated can be expanded. In addition, when the contents of an annotation can be customized, a more effective annotation can be obtained.

Software, such as NetMeeting, which transmits the screen image of an application to another person to further advance the progress of a collaboration, has a whiteboard function in addition to the application sharing function. The whiteboard function is a painting tool to which the image sharing function has been added, and according to this function, an image can be directly drawn on a current web page, so that in real time, the image drawn on the canvas of the tool can be shared with another person. With this function, the capture of the image of a desktop or of a window can also be transmitted to another person to request the entry of additional writing. However, with the whiteboard function, an annotation can not be written to a local application employed by a user, and therefore, the whiteboard function is not a satisfactory annotation function.

Furthermore, in Japanese Unexamined Patent publication No. Hei 10-254669, a technique is disclosed for displaying an applet as a map on a browser, and for displaying thereon, as accompanying information, a moving image icon representing an object such as a specific, current location. However, according to the technique disclosed in this publication, an application is one that is accompanied only by the applet of a browser, and the application is therefore limited. Further, merely one part of an application at a local user is annotated, and it is not taught in the publication that an annotation mark, for example, can be moved by a manipulation performed by an operator.

### SUMMARY OF THE INVENTION

To resolve the above shortcomings, it is one object of the present invention to provide a collaboration tool for remote hosts to annotate an arbitrary application window.

It is another object of the present invention to enable the use of a moving picture (a line, a circle, an arrow or a mascot) as an annotation object, and to customize an annotation object for each system.

It is an additional object of the present invention to annotate moving picture applications.

It is a further object of the present invention to rearrange annotations and to add annotations to areas separated from application windows.

The present invention uses an annotation object as the topmost (TOPMOST) window that can be arbitrarily shaped to perform an annotation function for drawing the attention of another person by adding writing to various applications. At this time, as a collaboration tool used by remote hosts, an annotation can be performed for an arbitrary window from a Java application. That is, according to one aspect of the present invention, an annotation method for collaboration by interconnected hosts comprises the steps of: annotating an application window that is displayed on a display unit; forming or selecting an annotation object that is constructed separately from an application that constructs the application window; determining a display position for the annotation object and displaying the annotation object thereat; and transmitting to the interconnected hosts a request event for the sharing of the annotation object, so that the annotation object can be shared by the hosts.

The annotation object is displayed in a window having a TOPMOST attribute so that the window is always displayed in the foreground. Since the annotation function can be employed without any special changes being made, this configuration is preferable regardless of whether an application to be annotated is possessed by a local user. The annotation object is displayed by forming a window from which a portion not required for the annotation is removed. Thus, the application to be annotated can be protected from being completely covered by the annotation object.

Further, the annotation object is an object possessing mobility. This arrangement is superior as an annotation function that will draw the attention of a customer. More specifically, for example, an Image object of the Java as an annotation object in an arbitrary shape can be employed based on an image (a moving picture) handled by Java. In addition, the annotation method further comprises the step of receiving from the interconnected hosts the images displayed in the application windows when images displayed on desktops by the hosts differ.

According to another aspect of the invention, a method for additional writing to an application window displayed on a desktop comprises the steps of: selecting an object for additional writing to the application window; and displaying a window, from which an unnecessary portion has been removed, for the object by employing a window having a TOPMOST attribute to display the object in the foreground screen on the desktop. More specifically, a set of rectangles is formed of pixels for which the occupation rate is not zero, and a region is generated using a region function, so that the shape of the window can be set so as not to include a transparent portion.

According to an additional aspect, a computer apparatus employing the present invention comprises: a display unit, for displaying an application window; an annotation object definition file, for storing an annotation object that is formed without depending on an application that has constructed the application window; a window shaping unit, for shaping a window for displaying the stored annotation object; an object selector, for selecting an annotation object that is additionally written in the application window; and a location selector, for designating a location, for the display of the selected annotation object, that corresponds to a predetermined position in the application window, wherein the display unit displays an annotation object window shaped by the window shaping unit at the location designated in the application window.

The window shaping unit detects a transparent attribute of an object, which is information for the annotation object, and permits a predetermined image that is positioned at the predetermined location in the application window to be seen through.

The computer apparatus further comprises: a sharing request transmitter for transmitting an annotation object sharing request to a computer apparatus that is connected thereto. Thus, collaborating remote hosts can share information and can use the same annotation.

An automatic contract machine that employs the present invention comprises: display means, for displaying predetermined windows, including an application window employed when jointly preparing a contract with a customer; and reception means, for receiving, from a connected host apparatus, a request event for the sharing of an object that is used to draw the attention of a customer to the application window, wherein the display means processes the object based on the sharing request event, and displays an object window in the application window.

In the process performed for the object by the display means, a location for the display of the object is designated, and a window designated for the object is shaped using a region function. Thus, an annotation object having an arbitrary shape can be employed by providing a desired image for an Image object prepared with Java.

According to a further aspect of the invention, a system for collaboration by a first host and a second host is provided, the first host comprising means for forming or selecting an annotation object to be used when annotating an application window displayed by the second host, and means for transmitting, to the second host, a request event for the sharing of the annotation object that is formed or selected, and the second host comprising means for receiving from the first host, the request event for the sharing of the annotation, means for processing the annotation object based on the sharing request event, and means for displaying with the application window a window concerning the annotation object that has been processed.

The first host further comprises: means for displaying a predetermined application window and the selected annotation object, wherein the same application window as an application window displayed by the second host, is displayed by the means for displaying, and wherein the annotation object is displayed on the application window. Further, the first host comprises: acquisition request means for requesting the second host the acquisition of a currently displayed application window.

According to a still further aspect of the invention, a computer-readable storage medium for storing a program that permits a computer to perform: a process for forming or selecting an annotation object to draw attention to a specific portion of a desktop image displayed on a desktop; a process for determining a display position for the annotation object; and a process for transmitting, to a connected host, a sharing request event that includes information concerning the annotation object and the determined display position. A storage medium such as a CD-ROM can be employed for this purpose.

According to one more aspect of the invention, a computer program product for controlling the display of a computer comprises: a first sub-routine, stored on a storage medium, for permitting the computer to perform a process for designating a location on a desktop, whereat an annotation object window is displayed, for the writing and the display on the desktop of an additional application window; and a second sub-routine, also stored on the storage medium, for permitting the computer to perform a process for displaying on the desktop screen, using a window having an attribute that ensures the window will be displayed in the foreground of the screen, an annotation object window in which an unnecessary portion is transparent.

According to yet one more aspect of the present invention, a program transmission apparatus comprises: storage means for storing a program that permits a computer to perform a process for forming or selecting an annotation object to draw attention to a specific portion of a desktop image displayed on a desktop, a process for determining a display position for the annotation object, and a process for transmitting, to a connected host, a sharing request event that includes information concerning the annotation object and the determined display position; and transmission means for reading the program from the storage means and for transmitting the program.

According to yet another aspect of the present invention, a program transmission apparatus comprises: storage means for storing a program that permits a computer to perform a process for designating a location on a desktop, whereat an annotation object window is displayed, for the writing and the display on the desktop of an additional application window, and a process for displaying on the desktop screen, using a window having an attribute that ensures the window will be displayed in the foreground of the screen, an annotation object window in which an unnecessary portion is transparent; and transmission means for reading the program from the storage means and for transmitting the program.

### BRIEF DESCRIPTION OF THE DRAWINGS

The present invention will now be described in detail during the course of an explanation of the preferred embodiment, given while referring to the accompanying drawings, in which:

FIG. 1 is a schematic diagram showing the configuration of an annotation window according to one embodiment of the present invention;

FIGS. 2A, 2B and 2C are diagrams showing the effects obtained by shaping a window;

FIG. 3 is a diagram showing an example window shaping method;

FIG. 4 is a functional block diagram explaining the general configuration of a control system according to the embodiment;

FIG. 5 is a flowchart explaining the processing performed by the control system according to the embodiment;

FIGS. 6A and 6B are diagrams showing an example format for an annotation object definition file and an example definition file;

FIG. 7 is a flowchart showing the event reception processing performed by an event receiver; and

FIG. 8 is a diagram showing an example display for an annotation object according to the embodiment.

### DETAILED DESCRIPTION OF THE INVENTION

Before beginning a detailed explanation of the functions of the system according to the present invention, the annotation method used for this embodiment will be described. As previously remarked, the annotation function is one that, for example, provides for the insertion of additional writing into a specific location on a screen in order to furnish a supplemental explanation which draws the attention of another person. This function can be further defined as one that exaggerates a specific portion of a screen for a customer. According to the method provided by this embodiment, effective lines, circles, ellipses, rectangles, arrows (pointing in all directions) and mascots (all of which are hereinafter referred to as annotation objects) are prepared using animated GIF (Graphics Interchange Format), and are so arranged at locations that draw the user's attention.

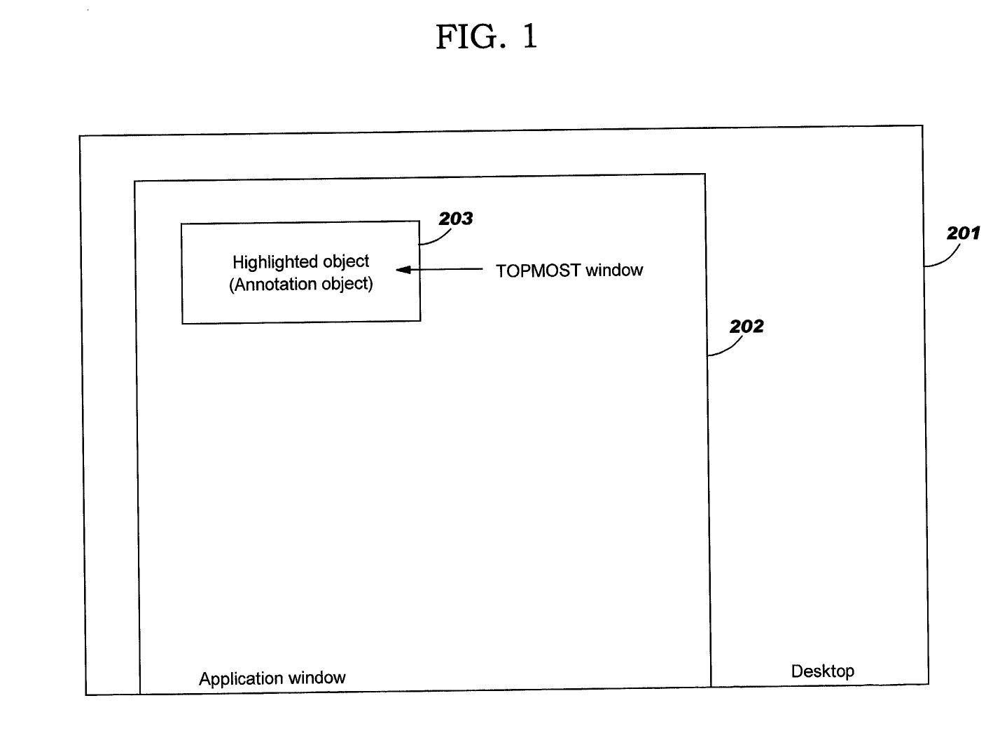

FIG. 1 is a schematic diagram for explaining the arrangement of an annotation window in accordance with one embodiment. In FIG. 1, an application window 202 is displayed on a desktop 201, and an annotation object 203 is displayed at a location to be annotated in the application window 202.

Since an application to be annotated may be independent of an application that provides an annotation tool, the annotation object cannot be directly written to the annotation target application. Therefore, in this embodiment, a window having a TOPMOST attribute is employed to display the annotation object 203. According to the TOPMOST attribute, the window is always displayed in the foreground of the desktop 201. When the window of the TOPMOST attribute is employed, the annotation function can be used regardless of the manufacturer of the target application.

As is described above, since the annotation object 203 must be displayed in front of the application window 202, the TOPMOST attribute is provided for the window, using Win32 (a 32-bit API built into Windows 95/98/NT/2000) by a JNI (Java Native Interface: an API (Application Program Interface) for employing, for a program written in the Java Language, a native code program that is developed in another language).

The substance of the annotation object 203 is defined by inheriting the Java base class. The base class is a Window object having a Panel object that is a standard Java AWT (Abstract Windowing Toolkit) component. When an arbitrary AWT component is combined thereon, the original annotation object can be obtained.

Since the window formed using the Java Window class is normally a rectangular window, it is difficult to say this window is appropriate for indicating a specific portion of an application. For example, when a desired portion to which attention is to be drawn is to be displayed with a circle or pointed at by an arrow, it would be meaningless for the circle or the arrow to be so placed in the window that it covers the application to be annotated. Thus, in the embodiment, Win32 is used for the JNI in order to form a window from which a portion unnecessary for annotation is removed. To do this, a function that will be described later is used to form a designated window shape indicated by a region object.

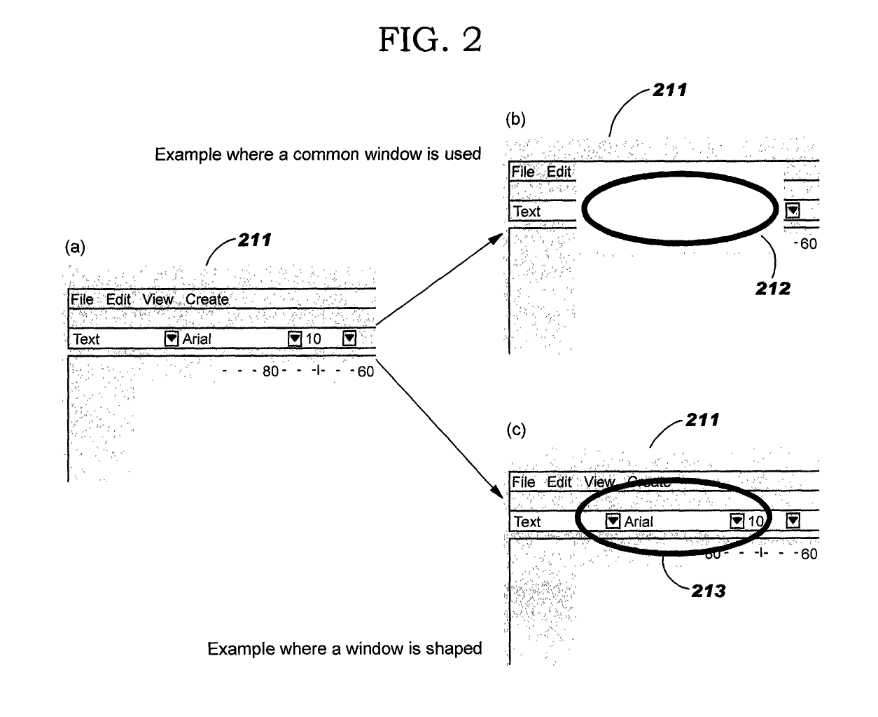

FIGS. 2A, 2B and 2C show the effects obtained by shaping a window. In FIG. 2A, no annotation is performed for an application window 211. In FIG. 2B, a common window 212 with no transparent attribute is used for annotation. In FIG. 2C, an annotation object window 213 is shaped in accordance with one embodiment of the present invention is employed. In FIG. 2B, an image file comprising the common window 212 with no transparent attribute is employed as an annotation object. In FIG. 2B the application window 211 is covered by the rectangular area. In FIG. 2C, the annotation object window 213 is shaped like an ellipse, and all the application window 211 other than the portion under the elliptical outline form is displayed. Further, since the annotation object window 213 has the TOPMOST attribute, i.e., the WS_EX_TOPMOST attribute for Windows, a window is provided that is always displayed as the topmost. As a result, this window can be displayed in different application programs (Microsoft Word, Internet explorer, etc.) running other Window processes.

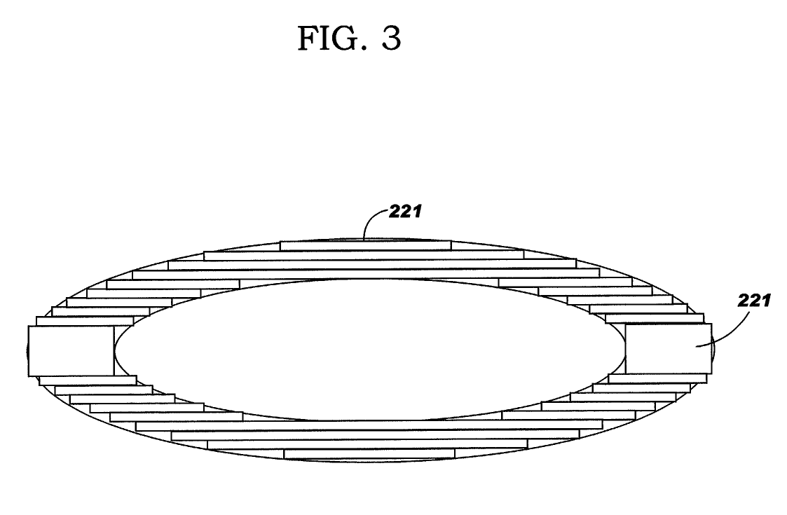

FIG. 3 shows an example window shaping method. In this example, the transparent attribute of the annotation object that constitutes the information for the annotation object is detected, and the non-transparent portion is divided into multiple rectangles 221. Then, the Window region objects are formed and unified to obtain a single region object. In FIG. 3, the shaping of an ellipse is shown. When this region object is transmitted to Windows, the shape of the form for the window can be prepared.

As used in this embodiment, a method based on the alpha plane of a Java Image object is employed. Specifically, a Java Image object is examined beginning at the end to find pixels whose occupation rate (alpha value) is not zero (pixels having an alpha value of 0 are transparent), and a set of rectangles 221 is obtained. Then, the region objects are formed by the region function of Win32 , and the shape of the window is set for one having no transparent portion. In this embodiment, a method is used whereby a region object is represented as a set of rectangular regions having an arbitrary shape. This is because the affect produced by the use of a division algorithm to reduce the number of rectangles 221 is taken into account.

Since a desired image need only be provided for the Image object, an annotation object having an arbitrary shape can be employed. Since the Java Image object is also compatible with animated GIF (Graphics Interchange Format), a moving annotation object can easily be designed using a tool such as a web animator. Furthermore, when the method for generating an image of the Image object from a program is employed, a more specialized annotation can be prepared.

When the annotation function of this embodiment is performed for an application on the screen of another party to a collaboration, the host of the other party must be notified the annotation operation is being used. The Java RMI can be employed to effect the notification of the display and the rearrangement performed for an annotation object and an event process. Further, since whether or not each annotation object should be displayed on the screen of the other party can be set as needed, the interface for displaying the annotation object can be prepared after the positioning and the alteration of the size of the object have been performed. In addition, an annotation object operation using a mouse can also be reported to the other party in real time. Furthermore, when the window layouts on the screens of the hosts that are parties to a collaboration differ, one host employs a tool that receives the screen image from the other host and designates the annotation location.

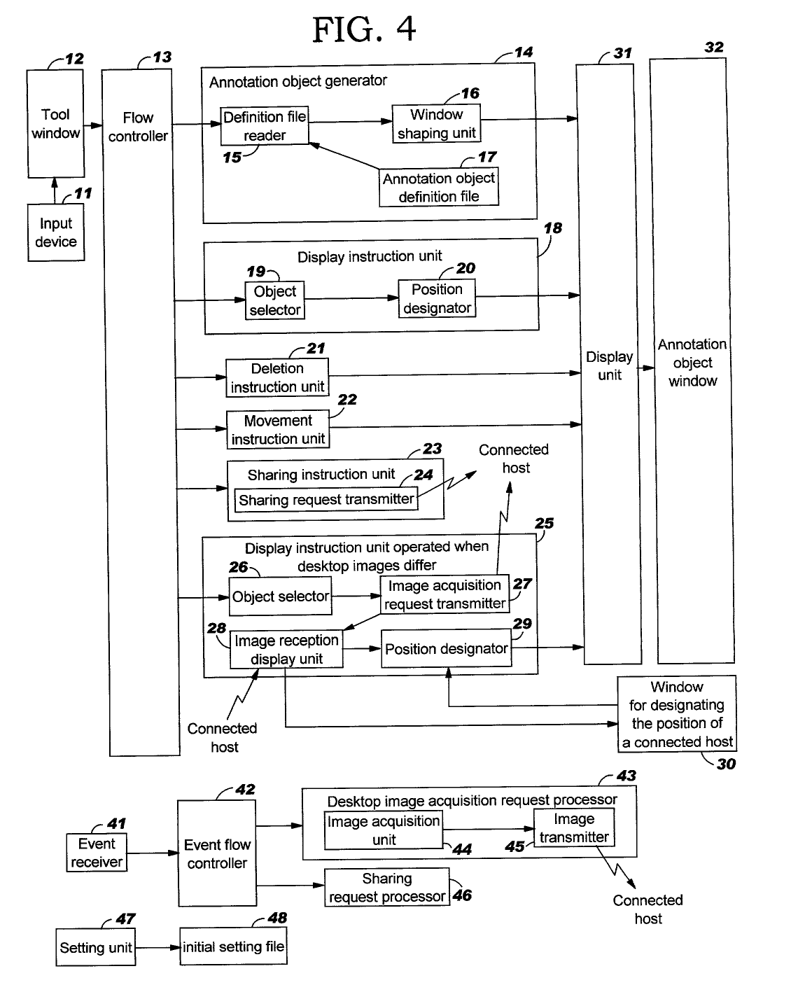

An explanation will now be given for the general configuration of a control system that carries out the annotation method and for the processing that is performed. FIG. 4 explains the general arrangement of the control system of this embodiment. The control system in FIG. 4 constitutes a function with which each host (PC terminal, etc.) that is a party to a collaboration is equipped. For example, in a financial facility such as a bank, this system is installed in an automatic contract machine provided for customer use and in a server provided for bank use. It should be noted, however, that the automatic contract machine provided for customer use may only display an annotation object window, and that the functions for forming, selecting and transmitting an annotation object window may be removed.

In FIG. 4, upon the receipt of an entry from an input device 11, such as a keyboard or a pointing device such as a mouse, a tool window 12 selects a function for a display instruction, a deletion instruction, a movement instruction, a sharing instruction or a display instruction when desktop images differ. Based on the selection made by the tool window 12, a flow controller 13 assumes control of the selected function. In an annotation object generator 14, a definition file reader 15 reads an annotation object definition file 17, obtains information concerning the annotation object information, and transmits the information to a window shaping unit 16. The window shaping unit 16 detects the transparent attribute of the annotation object included in the information, divides the non-transparent portion into multiple rectangles 221 (as shown in FIG. 3), forms region objects for the Windows, and collects them into one region object, and outputs the region object to a display unit 31.

In a display instruction unit 18, an object selector 19 selects a necessary annotation object from multiple objects that are prepared in advance by the annotation object generator 14. A position designator 20 determines a display position for the annotation object selected by the object selector 19 and outputs the display position to the display unit 31. Upon the receipt of an instruction from the position designator 20, the display unit 31 displays an annotation object window 32. Then, a deletion instruction unit 21 issues an instruction to the display unit 31 to delete the annotation object window 32, while a movement instruction unit 22 notifies the display unit 31 of a position after a movement has been performed and changes the display position of the annotation object window 32.

The sharing instruction unit 23 includes a sharing request transmitter 24 for transmitting a sharing request event to a connected host, which, for example, is a PC based on TCP/IP, and, for a financial facility, corresponds to an automatic contract machine or a server installed for the use of a bank. When the annotation object is shared by the hosts in response to a sharing request from the sharing request transmitter 24, the name, position, display and deletion functions for the annotation object are synchronized. Additionally, the sharing request event that is issued includes information for the name and the position of the annotation object, and for the display or deletion of the object.

An object selector 26 in the display instruction unit 25 selects a necessary annotation object from among multiple objects prepared in advance by the nnotation object generator 14. Further, an image acquisition request transmitter 27 transmits a request event to obtain, from a connected host, a desktop image, and upon receipt of the desktop image an image reception and display unit 28 displays it in a window 30 for designating the location of the connected host. Then, based on the information displayed in the window 30, a position designator 29 determines the display position for the annotation object and the display unit 31 displays the annotation object window 32 at the determined position.

An event receiver 41 receives an event from the connected host, and an event flow controller 42 controls a succeeding process in accordance with the type of received event, either a sharing request event or a desktop image acquisition request event. In a desktop image acquisition request processor 43, an image acquisition unit 44 obtains a currently displayed desktop image, and an image transmitter 45 transmits an image file to the connected host. A sharing request processor 46 then processes a target annotation object in accordance with the information included in the sharing request.

At a setup time, such as upon the activation of the system, a setting unit 47 is called to write an initial value (a path for the annotation object definition file 17) to an initial setting file 48.

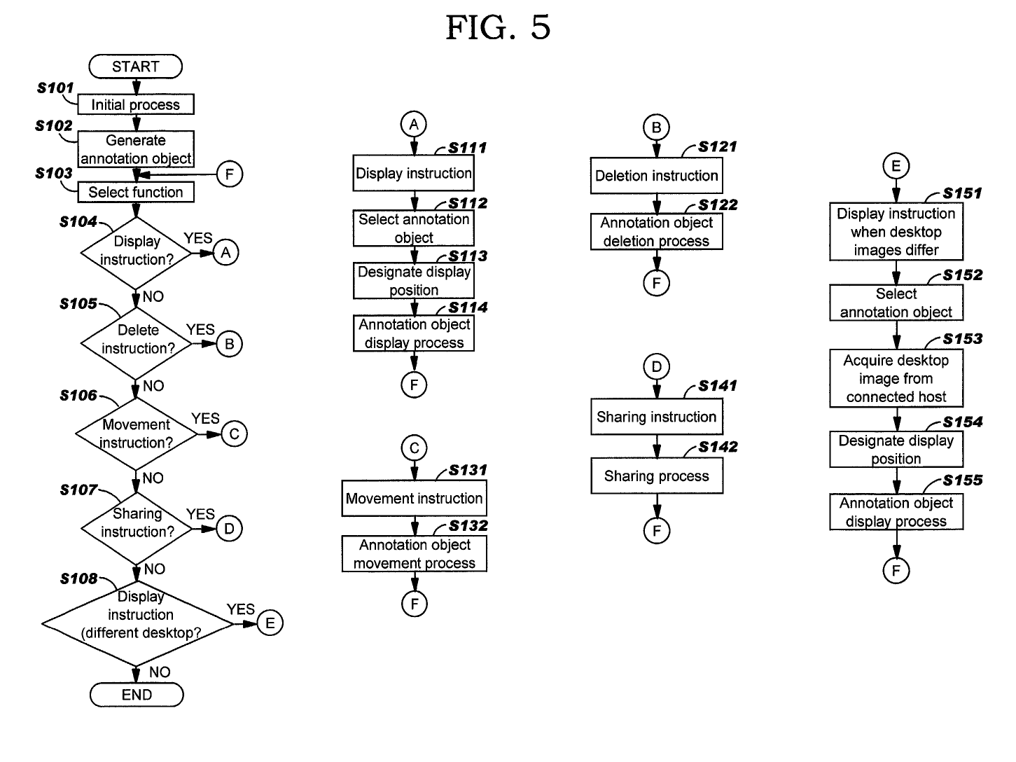

FIG. 5 is a flowchart explaining the processing performed by the control system in accordance with the embodiment. First, during the initial process, an initial value (a path for the annotation object definition file 17) is read from the initial setting file 48, and is transmitted to the flow controller 13 (step 101). Then the annotation object generator 14 reads the annotation object definition file 17, obtains the annotation object information, transmits it to the window shaping unit 16, and generates the annotation object (step 102). Then, when desktop images differ, the tool window 12 selects a function for the display instruction, the deletion instruction, the movement instruction, the sharing instruction or the display instruction (step 103).

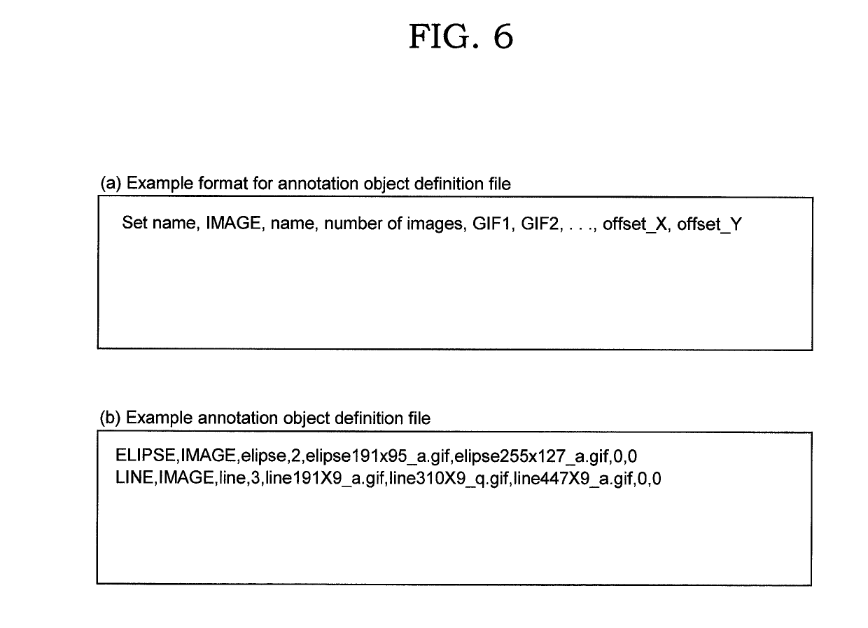

FIG. 6A shows an example format for the annotation object definition file 17. FIG. 6B shows an example of an annotation object definition file 17. In the format example in FIG. 6A, information such as the set name and the number of images is stored. In FIG. 6B the annotation object definition file 17, stores information such as a name for identifying an ellipse (ELLIPSE) or a line (LINE) and a moving picture comprising a plurality of structures. As is shown, the annotation object definition file 17 can be customized for each company, i.e., for each customer who operates the collaboration system. For example, in a bank system, a character used by each bank can be defined as an annotation object, and a more effective annotation process can be performed.

Referring again to FIG. 5, when the display instruction function is selected (step 104), program control is shifted to routine A. When the deletion instruction function is selected (step 105), program control is shifted to routine B. Then, when the movement instruction function is selected (step 106), program control is shifted to routine C, and when the sharing instruction function is selected (step 107), program control is shifted to routine D. Thereafter, when the display instruction function that is used when desktop images differ is selected (step 108), program control is shifted to routine E, and when routines A to E are terminated, program control returns from F to step 103 and the process for the selected function is performed.

In routine A, i.e., when the display instruction function is selected (step 111) from multiple annotation objects that are prepared in advance by the annotation object generator 14, the object selector 19 of the display instruction unit 18 selects a necessary annotation object (step 112). The tool window 12 may be employed for this object selection, or the API may select the object from a program. Thereafter, the display position of the annotation object is designated by the position designator 20 (step 113), and the annotation object display process is performed to display the annotation object window 32 on the display unit 31 (step 114). Then, when the display instruction process is terminated, program control returns to F to wait for the selection of a new function.

In routine B, i.e., when the deletion instruction function is selected (step 121), the deletion instruction unit 21 performs the annotation object deletion process (step 122). During this process, a deletion instruction is issued to the display unit 31, and the annotation object window 32, which is displayed once, is deleted. Then, when the deletion process is terminated, program control returns to F to wait for the selection of a new function.

In routine C, i.e., when the movement instruction function is selected (step 131), the movement instruction unit 22 performs the annotation object movement process (step 132). During this process, in order to move the annotation object, which is displayed once, the movement instruction unit 22 notifies the display unit 31 of the location following the movement, and changes the display position of the annotation object window 32. Thereafter, program control returns to F and waits for the selection of a new function.

In routine D, i.e., when the sharing instruction function is selected (step 141), the sharing process is performed by the sharing instruction unit 23 (step 142). During this process, the sharing request transmitter 24 transmits a sharing request event to a connected host. More specifically, on the reception terminal side, the annotation object (annotation content) is arranged using the input device 11, such as a mouse, and an instruction is issued for the object to also be displayed on the sharing party side. Then, when the annotation object is also displayed by the sharing party and is shared by the hosts, the positioning, the displaying and the deletion of the annotation object are synchronized. Thereafter, program control returns to F and waits for the selection of a new function.

In routine E, i.e., when the display instruction function used when desktop images differ is selected (step 151), the object selector 26 of the display instruction unit 25, which is operated when the desktop images differ, selects a necessary annotation object from among those prepared in advance by the annotation object generator 14 (step 152). Thereafter, the image acquisition transmitter 27 and the image reception/display unit 28 obtain a desktop image from the connected host (step 153), and the position designator 29 designates the display position (step 154). Then, the display unit 31 displays the annotation object window 32 (step 155). Thereafter, program control returns to E and waits for the selection of a new function. As is described above, when the desktop images of the hosts differ, i.e., when the desktop display contents at the reception and the sharing party's terminals differ, the annotation object can be displayed only on the sharing party side. In order to position the annotation object on the sharing party's screen, the desktop image on the sharing party's side can be captured and be converted into a GIF file or a JPEG file, which can then be transmitted to the reception terminal. Then, the received annotation object can be displayed in the window at the reception terminal and the positioning determined, so that the annotation object can be displayed on the sharing party's side.

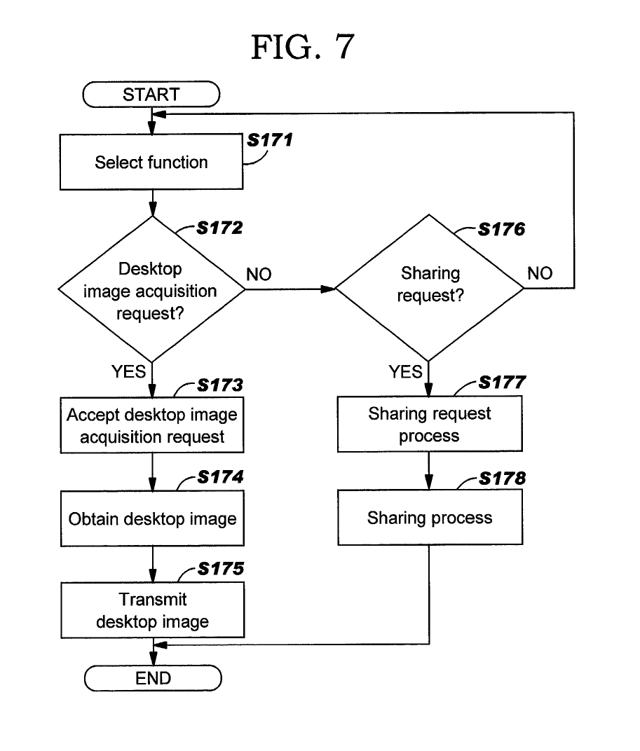

FIG. 7 shows the event reception processing performed by the event receiver 41 for an event transmitted by a connected host. First, the function is selected as an event type (step 171), which, as previously described, is a sharing request event or a desktop image acquisition request event. A check is then performed to determine whether the event is a desktop image acquisition request (step 172), and when the event type is a desktop image acquisition request, it is accepted (step 173). Following this, the image acquisition unit 44 obtains a desktop image (step 174) that the image transmitter 45 transmits (step 175). The processing is thereafter terminated.

If the event type at step 172 is not a desktop image acquisition request, a check is performed to determine whether the event is a sharing request (step 176). If the event type is not a sharing request, program control returns to step 171 and waits for selection of a function. If the event type is a sharing request, the sharing request processor 46 performs the sharing request process (step 177) and the sharing process for handling the annotation object designated by the information included in the sharing request event (step 178). Thereafter, the process sequence is terminated.

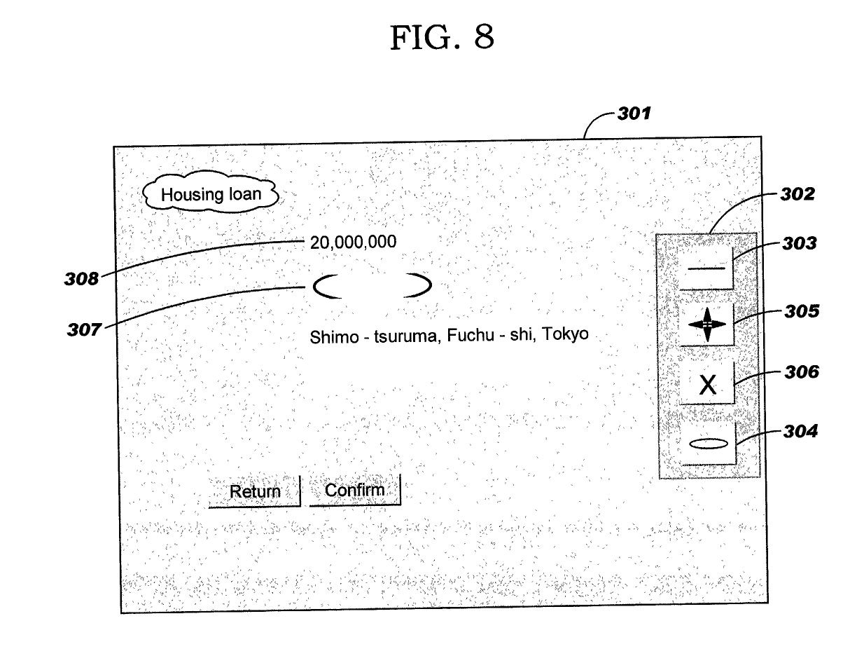

FIG. 8 shows an example display for an annotation object according to the embodiment. Annotation objects are displayed in an application window 301, which is, for example, an input screen for procedures provided by an automatic contract machine. A tool window 302, comprising four buttons, is provided in the application window 301. The tool window 302 includes a line annotation object button 303 which uses underlining for annotation, an ellipse annotation object button 304 which uses an elliptic shape for annotation, a sharing button 305 which is used for sharing an annotation object with another party, and a deletion button 306 for deleting the annotation object. When a user calls an annotation object window using the line annotation object button 303 and the ellipse annotation object button 304 to issue a movement instruction, the user can, for example, use the mouse to perform the drag and drop operation. Further, in addition to issuing an instruction for moving from the tool window 302, the user can also, for example, operate the mouse or depress the tab key to detect an event wherein the object is brought into focus or a focus is lost, and can display the event on the upper left of the object that is brought into focus. This method can be used as an auxiliary application for a manipulation by the operator.

In the example display in FIG. 8, an elliptic annotation object window 307 and an annotation object window 308 (having the form of a character mark) are shown. Because of the TOPMOST attribute, the annotation object windows 307 and 308 are displayed in the application window 301. A portion of each of these windows not required for annotation has been removed and includes a transparent attribute. In addition, the elliptic annotation object window 307 is displayed using a moving picture that dynamically draws, for example, a red and orange colored ellipse. Other annotation objects can be used, such as a mascot symbolizing the bank depicted as a moving picture.

Several display methods can be employed. For example, after the image file for a moving picture has been displayed for a specific period of time, the image file for a static image can be displayed. According to this method, when multiple annotation objects are arranged in a window, attention will be drawn to the annotation object that is last displayed. An image file for a moving picture that continues to be displayed is an effective annotation method for continuously attracting attention to the annotation object.

As is described above in detail, according to the embodiment, the annotation object, which is the TOPMOST window and that can be formed using an arbitrary shape, can be employed to annotate various applications that include moving pictures. That is, instead of writing directly into a sharing window, the annotation object is independently formed, and thus, an object window can be written into a moving picture (e.g., an Applet, animated GIF, Shockwave, etc.). By using this function, annotation objects can also be easily rearranged.

Since a standard AWT component is used as a base, the original annotation object can be easily generated, and can be customized for each system. Further, while an Image object is employed, an annotation object having an arbitrary shape can be employed based on an image (a moving picture) handled by Java. In a collaboration entered into by remote hosts sharing a screen or an application, a situation exists where the hosts converse while designating a specific point on the screen. According to this embodiment, a smooth communication is ensured.

A program for performing the annotation process explained in this embodiment is stored on a storage medium and is provided for sale. This storage medium can be one, such as a CD-ROM, on which software for performing the above process is stored. Further, when downloading this program across a network, a storage medium for a program transmission apparatus, or a storage medium such as a hard disk for storing the downloaded program, can also be used. The program that is stored on a storage medium can be read by input means, such as a CD-ROM driver. Further, a program transmission apparatus need only include, for example, interface means (transmission means) for, upon the receipt of a downloading request from a PC terminal connected to the Internet, transmitting a program that carries out the embodiment.

As is described above, according to the present invention, annotation can be performed for windows provided by various applications. When the present invention is applied to a system used for collaboration, explanations can be smoothly exchanged among remote hosts.

What is claimed:

1. An annotation method for collaboration among a plurality of interconnected hosts, comprising the steps of:
annotating an application window that is displayed on a display unit;
forming or selecting an annotation object that is constructed separately from an application that constructs said application window;
determining a display position for said annotation object and displaying said annotation object thereat; and
transmitting to said plurality of interconnected hosts a request event for the sharing of said annotation object, so that said annotation object can be shared by said plurality of hosts.

2. The annotation method according to claim 1, wherein said annotation object is displayed in a window having a TOPMOST attribute so that said window is always displayed in the foreground.

3. The annotation method according to claim 2, wherein said annotation object is displayed by forming a window from which a portion not required for the annotation is removed.

4. The annotation method according to claim 1, wherein said annotation object is an object possessing mobility.

5. The annotation method according to claim 1, further comprising the step of:
receiving from said plurality of interconnected hosts images displayed in said application window when said images displayed on desktops by said plurality of hosts differ.

6. A method for additional writing to an application window displayed on a desktop, comprising the steps of:
selecting an object for additional writing to said application window; and
displaying a window, from which an unnecessary portion has been removed, for said object by employing a window having a TOPMOST attribute to display said object in the foreground screen on said desktop.

7. The method according to claim 6, wherein, at said step of displaying a window, a set of rectangles is formed of pixels for which an occupation rate is not zero, and a region is generated using a region function, so that the shape of said window can be set so as to not include a transparent portion.

8. A computer apparatus comprising:
a display unit for displaying an application window;
an annotation object definition file for storing an annotation object formed without dependence on an application that constructed said application window;
a window shaping unit, for shaping a window to display said stored annotation object;
an object selector for selecting an annotation object that is additionally written in said application window; and
a location selector for designating a location for the display of said selected annotation object, that corresponds to a predetermined position in said application window, wherein said display unit displays an annotation object window shaped by said window shaping unit at said designated location in said application window.

9. The computer apparatus according to claim 8, wherein said window shaping unit detects a transparent attribute of an object, which is information for said annotation object, and permits a predetermined image that is positioned at said predetermined location in said application window to be seen through.

10. The computer apparatus according to claim 8, further comprising:
a sharing request transmitter for transmitting an annotation object sharing request to a computer apparatus that is connected thereto.

11. An automatic contract machine comprising:
means for displaying predetermined windows including an application window employed when jointly preparing a contract with a customer; and
means for receiving from a connected host apparatus, a request event for the sharing of an object that is used to draw the attention of a customer to said application window, wherein said means for displaying processes said object based on said sharing request event, and displays an object window in said application window.

12. The automatic contract machine of claim 11, wherein said means for displaying designates a location for said object, and a window designated for said object is shaped using a region function.

13. A system for collaboration between a first host and a second host, wherein said first host comprises:
selection means, for forming or selecting an annotation object to be used when annotating a first application window displayed by said second host; and
transmission means, for transmitting, to said second host, a request event for the sharing of said annotation object that is formed or selected; and
said second host comprises:
reception means, for receiving from said first host said request event for the sharing of said annotation;
processing means, for processing said annotation object based on said sharing request event; and
first display means, for displaying with said first application window a second window containing said processed annotation object.

14. The collaboration system according to claim 13, wherein said first host further comprises:
second display means, for displaying a predetermined third application window and said selected annotation object, wherein said third application window is the same as said second application window displayed by said second host, and wherein said annotation object is displayed on said third application window.

15. The collaboration system according to claim 13, wherein said first host further comprises:
acquisition request means for requesting from said second host a currently displayed application window.

16. A computer-readable storage medium for storing a program that permits a computer to perform:
a process for forming or selecting an annotation object to draw attention to a specific portion of a desktop image displayed on a desktop;
a process for determining a display position for said annotation object; and
a process for transmitting, to a connected host, a sharing request event that includes information concerning said annotation object and said determined display position.

17. A computer program product for controlling the display of a computer, comprising:
a first sub-routine, stored on a storage medium, for permitting said computer to perform a process for designating a location on a desktop, whereat an annotation object window is displayed, for the writing and the display on said desktop of an additional application window; and
a second sub-routine, also stored on said storage medium, for permitting said computer to perform a process for displaying on said desktop screen, using a window having an attribute that ensures said window will be displayed in the foreground of the screen, an annotation object window in which an unnecessary portion is transparent.

18. A program transmission apparatus comprising:
storage means for storing a program that permits a computer to perform:
a process for forming or selecting an annotation object to draw attention to a specific portion of a desktop image displayed on a desktop;
a process for determining a display position for said annotation object; and
a process for transmitting, to a connected host, a sharing request event that includes information concerning said annotation object and said determined display position; and
transmission means for reading said program from said storage means and for transmitting said program.

19. A program transmission apparatus comprising:
storage means for storing a program that permits a computer to perform:
a process for designating a location on a desktop screen, whereat an annotation object window is displayed, for the writing and the display on said desktop screen of an additional application window;
a process for displaying on said desktop screen, using a window having an attribute that ensures said window will be displayed in the foreground of said desktop screen, an annotation object window in which an unnecessary portion is transparent; and
transmission means for reading said program from said storage means and for transmitting said program.
